(19) United States
(12) Patent Application Publication
(10) Pub. No.: US 2020/0322498 A1
(43) Pub. Date: Oct. 8, 2020

(54) POWER SUPPLY VOLTAGE DETERMINATION DEVICE, IMAGE PROCESSING APPARATUS, POWER SUPPLY VOLTAGE DETERMINATION METHOD, AND RECORDING MEDIUM

(71) Applicants: ATSUSHI OKADA, KANAGAWA (JP); YUUKI MOGI, KANAGAWA (JP)

(72) Inventors: ATSUSHI OKADA, KANAGAWA (JP); YUUKI MOGI, KANAGAWA (JP)

(73) Assignee: Ricoh Company, Ltd., Tokyo (JP)

(21) Appl. No.: 16/826,444

(22) Filed: Mar. 23, 2020

(30) Foreign Application Priority Data
Apr. 4, 2019 (JP) 2019-072188

(51) Int. Cl. H04N 1/00

(52) U.S. Cl. CPC H04N 1/00888; H04N 1/00899; H04N 1/00087; H04N 1/00031

(57) ABSTRACT

A power supply voltage determination device includes a variable output power supply circuit and control circuitry. The variable output power supply circuit is configured to output an output voltage to a device. The control circuitry is configured to control the variable output power supply circuit. The control circuitry determines a power supply voltage to be supplied to the device, based on the output voltage in a case where communication with the device has been successfully performed during an increase of the output voltage.

### CROSS-REFERENCE TO RELATED APPLICATION

This patent application is based on and claims priority pursuant to 35 U.S.C. § 119(a) to Japanese Patent Application No. 2019-072188, filed on Apr. 4, 2019, in the Japan Patent Office, the entire disclosure of which is hereby incorporated by reference herein.

### BACKGROUND

### Technical Field

Aspects of the present disclosure relate to a power supply voltage determination device, an image processing apparatus, a power supply voltage determination method, and a recording medium.

### Related Art

There has been conventionally known a technique of supplying a constant value of power supply voltage predetermined by a controller of an image forming apparatus to devices such as wireless local area network (LAN) devices, universal serial bus (USB) memories, and secure digital (SD) cards connected to the image forming apparatus.

However, the specifications of the power supply voltage of the devices are varied, and in recent years, in order to increase the performance of the devices and respond to user needs, there has been an increasing number of cases where the connected devices are running changed in specification of a power supply voltage. Accordingly, there is an increasing demand for a technique of dynamically determining a power supply voltage to be supplied to devices.

### SUMMARY

In an aspect of the present disclosure, there is provided a power supply voltage determination device that includes a variable output power supply circuit and control circuitry. The variable output power supply circuit is configured to output an output voltage to a device. The control circuitry is configured to control the variable output power supply circuit. The control circuitry determines a power supply voltage to be supplied to the device, based on the output voltage in a case where communication with the device has been successfully performed during an increase of the output voltage.

In another aspect of the present disclosure, there is provided an image processing apparatus that includes the power supply voltage determination device.

In still another aspect of the present disclosure, there is provided a power supply voltage determination method that includes outputting an output voltage to a device and controlling the outputting of the output voltage. The controlling includes determining a power supply voltage to be supplied to the device based on the output voltage in a case where communication with the device has been successfully performed during an increase of the output voltage.

In still yet another aspect of the present disclosure, there is provided a non-transitory recording medium storing computer readable program code which, when executed by one or more processors, cause the processors to perform a process. The process includes outputting an output voltage to a device and controlling the outputting of the output voltage output. The controlling includes determining a power supply voltage to be supplied to the device based on the output voltage in a case where communication with the device has been successfully performed during an increase of the output voltage.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a block diagram illustrating an example of a hardware configuration of a power supply voltage determination device according to an embodiment;

FIG. 2 is a diagram illustrating an example of a configuration of a variable output power supply circuit according to the embodiment;

FIG. 3 is a block diagram illustrating an example of a functional configuration of a power supply voltage determination device according to a first embodiment;

FIG. 4 is a flowchart illustrating an example of a process performed by the power supply voltage determination device according to the first embodiment;

FIG. 5 is a block diagram illustrating an example of a hardware configuration of an image forming apparatus including the power supply voltage determination device according to the first embodiment;

FIG. 6 is a block diagram illustrating an example of a functional configuration of a power supply voltage determination device according to a second embodiment; and

FIG. 7 is a flowchart illustrating an example of a process performed by the power supply voltage determination device according to the second embodiment.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Hereinafter, embodiments of the disclosure will be described with reference to the drawings. In the drawings, the same components are denoted by the same reference numerals, and redundant description may be omitted. Further, in the block diagrams describing the hardware configuration and the functional configuration described below, arrows of broken lines indicate supply lines of a power supply voltage, and arrows of solid lines indicate signal lines of control signals.

Hardware configuration of a power supply voltage determination device according to an embodiment

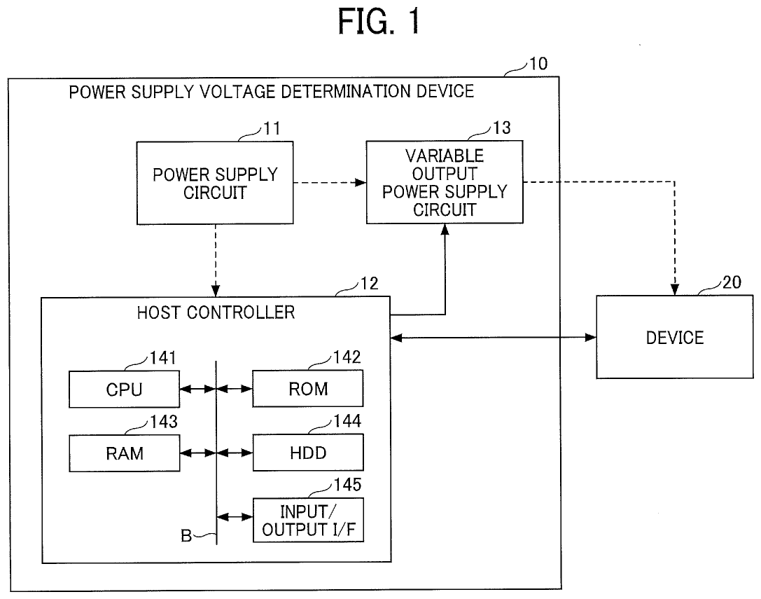

First, a hardware configuration of a power supply voltage determination device 10 according to the embodiment will be described. FIG. 1 is a block diagram illustrating an example of a hardware configuration of the power supply voltage determination device 10.

As illustrated in FIG. 1, the power supply voltage determination device 10 is formed by an electric circuit board or the like having a power supply circuit 11, a host controller 12, and a variable output power supply circuit 13.

The power supply circuit 11 is an electric circuit connected to a commercial power source. The power supply circuit 11 converts the value and frequency of the voltage input from the commercial power source so as to be suitable for the internal circuit of the power supply voltage determination device 10, and supplies the converted voltage to the host controller 12, the variable output power supply circuit 13, and others.

The host controller 12 controls the operations of a device 20 electrically connected to the power supply voltage determination device 10 and controls the operations of the variable output power supply circuit 13. Here, the device 20 is a wireless local area network (LAN) device, a universal serial bus (USB) memory, an SD card, or the like. The voltage value of the control signal for controlling the operations of the device 20 is the same as the value of the voltage supplied to the device 20.

The host controller 12 includes a central processing unit (CPU) 141, a read only memory (ROM) 142, a random access memory (RAM) 143, a hard disk drive (HDD) 144, and an input/output interface (I/F) 145 that are electrically connected to each other by a system bus B.

The CPU 141 reads out programs or data from a storage device such as the ROM 142 or the HDD 144 onto the RAM 143 and executes processing to implement control of the entire power supply voltage determination device 10 and functions to be described later. Note that some or all of the functions of the CPU 141 may be implemented by an electronic circuit such as an application specific integrated circuit (ASIC) or a field-programmable gate array (FPGA).

The ROM 142 is a non-volatile semiconductor memory (storage device) that can store programs and data even when the power is turned off. The ROM 142 stores programs and data such as a basic input/output system (BIOS) executed when the power supply voltage determination device 10 is started, and operating system (OS) settings. The RAM 143 is a volatile semiconductor memory (storage device) that temporarily stores programs and data.

The HDD 144 is a non-volatile memory that stores programs for the power supply voltage determination device 10 to execute processing and various types of data. The HDD 144 may be a solid state drive (SSD) or the like.

The input/output I/F 145 constitutes various interfaces for connecting to the device 20, the variable output power supply circuit 13, and the like.

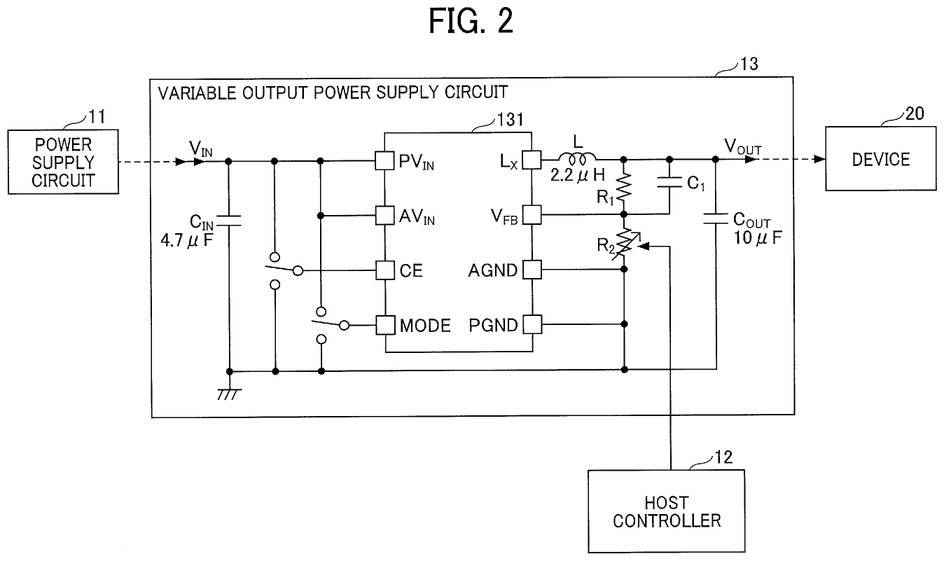

The variable output power supply circuit 13 converts the voltage input from the power supply circuit 11 into an output voltage with a value according to a control signal from the host controller 12 and outputs the output voltage to the device 20. Here, FIG. 2 is a diagram describing an example of a configuration of the variable output power supply circuit 13 in more detail.

The variable output power supply circuit 13 includes a direct current to direct current (DCDC) converter integrated circuit (IC) 131, an input terminal Vin, an output terminal Vout, and the like. The voltage supplied from the power supply circuit 11 is input to the DCDC converter IC 131 through the input terminal Vin.

The DCDC converter IC 131 converts the input DC voltage into a DC voltage of a predetermined voltage value and outputs the same. The voltage output from the DCDC converter IC 131 is further adjusted by resistance values of resistors R1 and R2, and is output to the device 20 through the output terminal Vout.

Here, the resistor R2 is a digital potentiometer or the like of which the resistance value changes according to a control signal from the host controller 12. The digital potentiometer is an electronic circuit component that sets a wiper of an analog variable resistor with a digital signal, and performs adjustment and trimming of an electronic circuit in the same manner as a variable resistor, a rheostat, a mechanical volume, and a mechanical potentiometer. The value of the output voltage to the device 20 is controlled by changes in the resistance value of the resistor R2 according to a control signal from the host controller 12.

### First Embodiment

Functional Configuration of a Power Supply Voltage Determination Device According to a First Embodiment

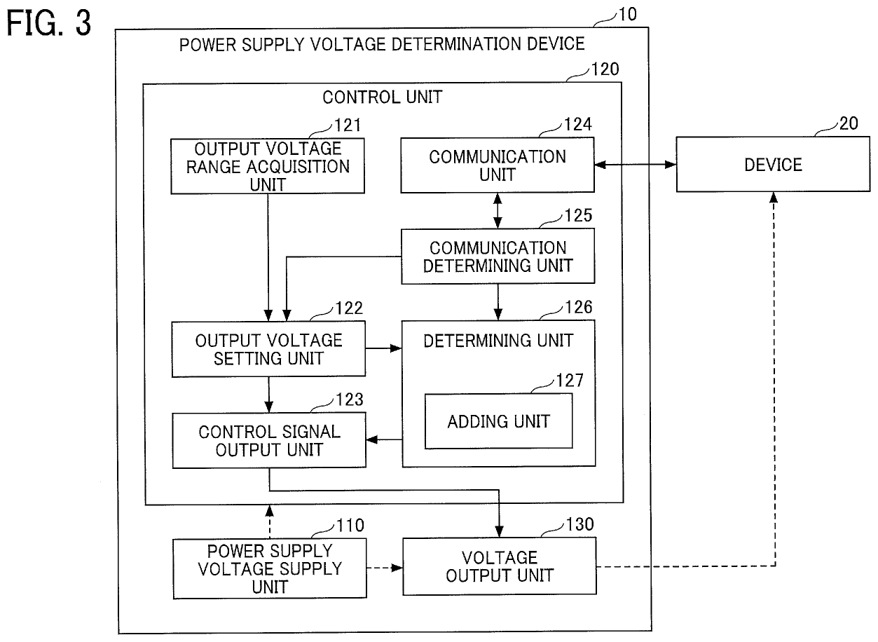

Next, a functional configuration of a power supply voltage determination device 10 according to the first embodiment will be described. FIG. 3 is a block diagram illustrating an example of a functional configuration of the power supply voltage determination device 10 according to the present embodiment. Note that the functional blocks illustrated in FIG. 3 are conceptual and do not necessarily need to be physically configured as illustrated. All or some of the functional blocks can be functionally or physically dispersed and combined in an arbitrary unit. As illustrated in FIG. 3, the power supply voltage determination device 10 includes a power supply voltage supply unit 110, a control unit 120, and a voltage output unit 130.

The power supply voltage supply unit 110 is implemented by the power supply circuit 11 and the like, converts the value and frequency of the voltage input from a commercial power source so as to be suited for the internal circuit of the power supply voltage determination device 10, and supplies the converted voltage to the control unit 120, the voltage output unit 130, and the like.

The control unit 120 is implemented by the host controller 12 or the like, and outputs a control signal for controlling the device 20 to the device 20, and outputs a control signal for controlling the operations of the voltage output unit 130 to the voltage output unit 130.

Further, the control unit 120 includes an output voltage range acquisition unit 121, an output voltage setting unit 122, a control signal output unit 123, a communication unit 124, a communication determining unit 125, and a determining unit 126. Among the units, the output voltage range acquisition unit 121, the output voltage setting unit 122, the communication determining unit 125, and the determining unit 126 are implemented by the CPU 141 of FIG. 1 executing predetermined programs. Further, the control signal output unit 123 and the communication unit 124 are implemented by the input/output I/F 145 and the like.

The output voltage range acquisition unit 121 acquires the minimum value and the maximum value of the output voltage as the range of the output voltage to be output to the device 20. The data of the minimum value and the maximum value of the output voltage are predetermined based on standards of the connection interface between the host controller 12 and the device 20 so that the standard value of the power supply voltage of the device 20 is within the range from the minimum value to the maximum value, and are stored in the HDD 144 or the like. The output voltage range acquisition unit 121 can acquire the minimum value and the maximum value of the output voltage with reference to the HDD 144 and the like. However, the present disclosure is not limited to such a configuration, and the output voltage range acquisition unit 121 may acquire the data of the minimum value and the maximum value of the output voltage from an external device such as a personal computer (PC) via the input/output I/F 145.

As an example, the minimum value is 0.5 V and the maximum value is 5 V. The output voltage range acquisition unit 121 outputs the acquired data of the minimum value and the maximum value of the output voltage to the output voltage setting unit 122.

The output voltage setting unit 122 sets the output voltage to the minimum value input from the output voltage range acquisition unit 121, and outputs the set voltage value data to the control signal output unit 123 and the determining unit 126. When the communication determining unit 125 described later determines that communication between the communication unit 124 and the device 20 has failed, the output voltage setting unit 122 adds a predetermined additional voltage value to the minimum value, and outputs the added value data of the output voltage to the control signal output unit 123 and the determining unit 126. The additional voltage value is, for example, 0.1 V.

More specifically, the output voltage setting unit 122 firstly sets 0.5 V, which is the minimum value of the output voltage of the device 20 input from the output voltage range acquisition unit 121, as the output voltage, and outputs the voltage value data to the control signal output unit 123 and the determining unit 126. After that, when the communication determining unit 125 determines that communication between the communication unit 124 and the device 20 has failed, the output voltage setting unit 122 sets 0.6 V obtained by adding 0.1 V to 0.5 V as the output voltage, and outputs the voltage value data to the control signal output unit 123 and the determining unit 126.

Then, until the communication determining unit 125 determines that communication between the communication unit 124 and the device 20 has been successfully performed, the output voltage setting unit 122 repeats setting of the output voltage with addition of 0.1 V and outputting of the value data of the output voltage to the control signal output unit 123 and the determining unit 126. The output voltage setting unit 122 outputs the value data of the output voltage to the RAM 143 illustrated in FIG. 1, and the determining unit 126 can acquire the voltage value data of the output voltage output by the output voltage setting unit 122 via the RAM 143.

The control signal output unit 123 outputs a control signal indicating the value of the output voltage from the output voltage setting unit 122 to the voltage output unit 130. The voltage output unit 130 outputs the output voltage with the value according to the input control signal to the device 20.

The communication unit 124 communicates with the device 20 via a connection interface corresponding to the type of the device 20. Further, the communication determining unit 125 monitors a communication state between the communication unit 124 and the device 20, and determines whether the communication has been performed.

With an input of the power supply voltage according to the connection interface standard, the device 20 can communicate data and signals with the connected host controller 12. However, the input power supply voltage may become lower than the standard value due to fluctuations or the like, or the actual power supply voltage value of the device 20 may have an error with respect to the standard value. Therefore, even if the power supply voltage in accordance with the connection interface standard is output to the device 20, communication with the host controller 12 may not be enabled.

In the present embodiment, the output voltage setting unit 122 gradually increases the output voltage to the device 20 by adding a predetermined additional voltage value to the minimum value of the output voltage. Then, each time the output voltage to which the additional voltage value is added is set, the communication unit 124 tries to communicate with the device 20, and the communication determining unit 125 can determine whether communication between the communication unit 124 and the device 20 has been performed.

As a result, even when communication is not possible when the voltage output unit 130 starts to output the output voltage to the device 20, communication will become possible in the process of gradually increasing the output voltage. Then, when communication between the communication unit 124 and the device 20 has been successfully performed, the communication determining unit 125 outputs a signal indicating that (hereinafter, referred to as a communication enabled signal) to the determining unit 126. On the other hand, when communication between the communication unit 124 and the device 20 has failed, the communication determining unit 125 outputs a signal indicating that (hereinafter, referred to as a communication disabled signal) to the output voltage setting unit 122.

With an input of the communication enabled signal from the communication determining unit 125, the determining unit 126 determines the value of the power supply voltage based on the value of the output voltage output from the output voltage setting unit 122.

More specifically, the determining unit 126 has an adding unit 127. With an input of the communication enabled signal from the communication determining unit 125, the adding unit 127 acquires the value of the output voltage output from the output voltage setting unit 122 via the RAM 143 and adds a predetermined margin voltage value to the value of the output voltage. The determining unit 126 determines the voltage value to which the margin voltage value is added as the value of the power supply voltage. The margin voltage value is 0.5 V as an example.

For example, when the communication between the communication unit 124 and the device 20 has been successfully performed when the output voltage is 3.3 V, the determining unit 126 determines the value of the power supply voltage as 3.8 V where the margin voltage value of 0.5 V is added to 3.3 V.

Here, the voltage value with which the communication has been first successfully performed with gradual voltage increase from the minimum value of the output voltage is the minimum output voltage value with which the communication is possible between the communication unit 124 and the device 20. Therefore, a margin voltage is added to this voltage value to approach the voltage value to the center value of the power supply voltage of the device 20. This makes it possible to prevent communication failure due to fluctuations in the power supply voltage or the like. After that, the determining unit 126 outputs a control signal indicating the determined value of the power supply voltage to the voltage output unit 130 via the control signal output unit 123.

The voltage output unit 130 outputs the power supply voltage according to the input control signal to the device 20. In this way, the appropriate power supply voltage can be determined and supplied to the device 20.

Processing by the power supply voltage determination device according to the first embodiment

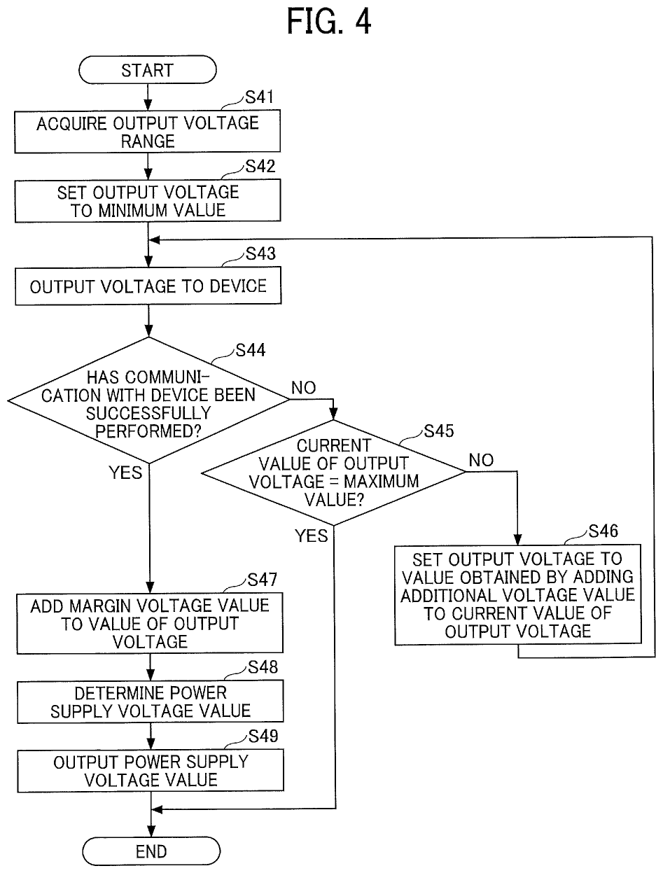

Next, a process performed by the power supply voltage determination device 10 according to the present embodiment will be described. FIG. 4 is a flowchart of an example of a process performed by the power supply voltage determination device 10.

First, in step S41, the output voltage range acquisition unit 121 refers to the HDD 144 or the like to acquire the data of the minimum value and the maximum value of the output voltage range predetermined so that the standard value of the power supply voltage of the device 20 is within the range, and outputs the same to the output voltage setting unit 122.

Subsequently, in step S42, the output voltage setting unit 122 sets the output voltage to the minimum value of the output voltage range input from the output voltage range acquisition unit 121. Then, the output voltage setting unit 122 outputs the set voltage value data to the control signal output unit 123 and the determining unit 126.

Subsequently, in step S43, the control signal output unit 123 outputs a control signal indicating the value of the output voltage input from the output voltage setting unit 122 to the voltage output unit 130. The voltage output unit 130 outputs the output voltage with the value according to the input control signal to the device 20.

Subsequently, in step S44, the communication unit 124 communicates with the device 20 via the connection interface. Further, the communication determining unit 125 monitors a communication state between the communication unit 124 and the device 20, and determines whether the communication has been performed.

When it is determined in step S44 that the communication unit 124 has not successfully communicated with the device 20 (No in S44), the communication determining unit 125 outputs a communication disabled signal to the output voltage setting unit 122, and then the process moves to step S45.

Subsequently, in step S45, the output voltage setting unit 122 determines whether the current value of the output voltage is equal to the maximum value of the output voltage range.

When determining in step S45 that the current value of the output voltage is equal to the maximum value of the output voltage range (Yes in step S45), the output voltage setting unit 122 determines that the power supply voltage of the device 20 cannot be determined, and the process is terminated. On the other hand, when not determining in step S45 that the current value of the output voltage is equal to the maximum value of the output voltage range (No in step S45), the output voltage setting unit 122 moves to step S46.

In step S46, the output voltage setting unit 122 sets the output voltage to a value obtained by adding the additional voltage value to the current voltage value. Then, the process moves to step S43 to execute again step S43 and the subsequent steps.

On the other hand, when determining in step S44 that the communication unit 124 has successfully communicated with the device 20 (Yes in S44), the communication determining unit 125 outputs a communication enabled signal to the determining unit 126, and then the process moves to step S47.

In step S47, with an input of the communication enabled signal from the communication determining unit 125, the determining unit 126 acquires the value data of the output voltage output by the output voltage setting unit 122 via the RAM 143 illustrated in FIG. 1. The adding unit 127 adds a predetermined margin voltage value to the acquired value of the output voltage.

Subsequently, in step S48, the determining unit 126 determines the power supply voltage value as the value of the output voltage to which the margin voltage value was added in step S47. Then, the determining unit 126 outputs a control signal indicating the determined value of the power supply voltage to the voltage output unit 130 via the control signal output unit 123.

Subsequently, in step S49, the voltage output unit 130 outputs the power supply voltage according to the input control signal to the device 20.

In this manner, the power supply voltage determination device 10 can determine an appropriate power supply voltage and supply the determined power supply voltage to the device 20. Gradually increasing the output voltage to the device 20 by adding an additional voltage from the minimum value makes it possible to prevent the device 20 from being broken by applying a large voltage to the device 20 in the process of determining the power supply voltage.

In the above-described example, the power supply voltage of one device 20 is determined. However, the present embodiment can be applied to a case where a plurality of devices 20 is connected to the power supply voltage determination device 10.

In this case, the data of the minimum value and the maximum value of the output voltage are predetermined such that the standard value of the power supply voltage of each of the plurality of devices is within a range from the minimum value to the maximum value based on the standards of connection interface between each of the plurality of devices and the host controller 12, and are stored in the HDD 144 or the like. The output voltage range acquisition unit 121 acquires the minimum value and the maximum value as a range of the output voltage to be output to each of the plurality of devices. Then, the process described above with reference to FIG. 4 is executed for each of the plurality of devices, and their respective power supply voltages are determined.

### Advantageous Effects

There has been conventionally known a technique of supplying a constant value of power supply voltage predetermined by a controller of an image forming apparatus to devices such as wireless local area network (LAN) devices, universal serial bus (USB) memories, and SD cards connected to the image forming apparatus. In this case, devices to be connected are selected at the design stage of the image forming apparatus, and the image forming apparatus is designed and manufactured in a manner suitable for the selected devices.

However, devices may have different power supply voltage specifications (standard values) even for the same function. For example, there are two types of secure digital input/output (SDIO) interface standard devices: one with a power supply voltage specified as 1.8 V and one with a power supply voltage specified as 3.3 V. In addition, devices under interface standards such as serial peripheral interface (SPI) standards or universal asynchronous receiver/transmitter (UART) standards are different in the specification of power supply voltage from 1.8 V to 5 V.

Further, in order to increase the performance of the devices and respond to user needs, there has been an increasing number of cases where the connected devices are running changed in the specification of a power supply voltage. If the device after the running change has a power supply voltage specification different from that of the device before the change, major hardware changes may be required to change the power supply voltage. Major hardware changes increase cost and effort. Therefore, there is an increasing demand for a technique for dynamically determining a power supply voltage to be supplied to devices without changing hardware.

The power supply voltage determination device 10 according to the present embodiment includes a voltage output unit 130 that outputs a predetermined output voltage to the device, and a control unit 120 that controls the voltage output unit 130. With an increase in output voltage, the control unit 120 determines the power supply voltage to be supplied to the device 20 based on the output voltage with which communication with the device 20 has been successfully performed. This makes it possible to dynamically determine an appropriate power supply voltage to be supplied to the device.

In the present embodiment, the control unit 120 determines a voltage value obtained by adding a predetermined margin voltage value to the value of the output voltage with which communication with the device 20 has been successfully performed, as the power supply voltage. Adding a margin (allowance) voltage to the minimum output voltage value with which communication between the communication unit 124 and the device 20 is allowed makes it possible to approach the center value of the power supply voltage of the device 20 and suppress a communication failure due to fluctuation in the power supply voltage or the like.

Furthermore, in the present embodiment, there is provided the output voltage range acquisition unit 121 that acquires the minimum value and the maximum value for changing the output voltage. The control unit 120 adds a predetermined additional voltage value to the acquired minimum voltage value to increase the output voltage. Then, the control unit 120 determines the power supply voltage to be supplied to the device 20 based on the output voltage with which communication with the device 20 has been successfully performed. Accordingly, it is possible to prevent the device 20 from being broken by applying a large voltage to the device 20 in the process of determining the power supply voltage.

Example of application of the power supply voltage determination device according to the embodiment to an image forming apparatus

Here, an example of application of the power supply voltage determination device 10 according to the embodiment to an image forming apparatus 9 as an example of an image processing apparatus will be described.

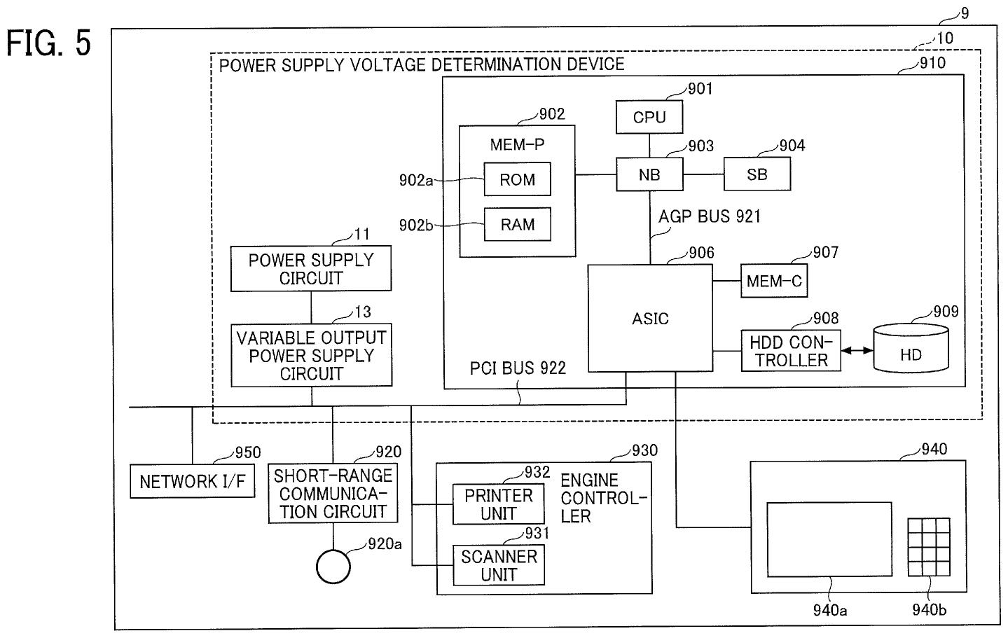

FIG. 5 is a block diagram illustrating an example of a hardware configuration of the image forming apparatus 9. The image forming apparatus 9 is, for example, a multifunction peripheral/product/printer (MFP) or the like.

As illustrated in FIG. 5, the image forming apparatus 9 includes a controller 910, a short-range communication circuit 920, an engine control unit 930, an operation panel 940, and a network I/F 950.

Among them, the controller 910 includes a CPU 901 as a main part of the computer, a system memory (MEM-P) 902, a north bridge (NB) 903, a south bridge (SB) 904, an ASIC 906, and a local memory (MEM-C) 907 as a storage unit, an HDD controller 908, and an HD 909 as a storage unit. Further, the NB 903 and the ASIC 906 are connected by an accelerated graphics port (AGP) bus 921.

Among them, the CPU 901 is a control unit that entirely controls the image forming apparatus 9. The NB 903 is a bridge for connecting the CPU 901 with the MEM-P 902, the SB 904, and the AGP bus 921. The NB 903 includes a memory controller that controls reading from and writing into the MEM-P 902, a peripheral component interconnect (PCI) master, and an AGP target.

The MEM-P 902 includes a ROM 902a that is a memory for storing programs and data for implementing the functions of the controller 910 and a RAM 902b that is used as a drawing memory or the like in developing programs and data and memory printing.

The programs stored in the RAM 902b may be provided in files in an installable format or an executable format in a manner that is recorded in a computer-readable recording medium such as a compact disc read only memory (CD-ROM), a compact disc recordable (CD-R), or a digital versatile disc (DVD).

The SB 904 is a bridge for connecting the NB 903 with PCI devices and peripheral devices. The ASIC 906 is an IC for image processing with a hardware element for image processing, and has a role of a bridge that connects the AGP bus 921, the PCI bus 922, the HDD 908, and the MEM-C 907.

The ASIC 906 includes the PCI target and the AGP master, an arbitar (ARB) that forms the core of the ASIC 906, a memory controller that controls the MEM-C 907, a plurality of direct memory access controllers (DMAC) that rotates image data by a hardware logic or the like, and a PCI unit that performs data transfer between the scanner unit 931 and the printer unit 932 via a PCI bus 922.

The ASIC 906 may be connected to a USB interface or an Institute of Electrical and Electronics Engineers (IEEE) 1394 interface.

The MEM-C 907 is a local memory used as a copy image buffer and a code buffer. The HD 909 is a storage for accumulating image data, accumulating font data used for printing, and accumulating forms. The HD 909 controls reading or writing of data from or into the HD 909 under the control of the CPU 901.

The AGP bus 921 is a bus interface for a graphics accelerator card that has been proposed to speed up graphics processing. By directly accessing the MEM-P 902 with high throughput, the graphics accelerator card can be operated at a high speed.

The short-range communication circuit 920 includes a short-range communication circuit 920a. The short-range communication circuit 920 is a communication circuit such as near field communication (NFC) and Bluetooth (registered trademark).

Further, the engine control unit 930 includes the scanner unit 931 and the printer unit 932. The operation panel 940 includes a panel display unit 940a such as a touch panel that displays current setting values, a selection screen, and others and accepts an input from an operator, and an operation panel 940b that includes a numeric keypad accepting setting values of conditions for image formation such as a density setting condition and a start key accepting a copy start instruction.

The controller 910 entirely controls the image forming apparatus 9 and controls rendering, communication, input from the operation panel 940, and others, for example. The scanner unit 931 or the printer unit 932 includes an image processing unit such as error diffusion or gamma conversion.

The image forming apparatus 9 can sequentially switch and select a document box function, a copy function, a printer function, and a facsimile function by using an application switching key on the operation panel 940.

The document box mode is set when the document box function is selected, the copy mode is set when the copy function is selected, the printer mode is set when the printer function is selected, and the facsimile mode is set when the facsimile mode is selected.

The network I/F 950 is an interface for performing data communication using a network. The short-range communication circuit 920 and the network I/F 950 are electrically connected to the ASIC 906 via the PCI bus 922.

Here, the image forming apparatus 9 has a power supply circuit 11 and a variable output power supply circuit 13. Further, the controller 910 includes the function of the host controller 12 described in relation to the first embodiment. Therefore, the image forming apparatus 9 includes the power supply voltage determination device 10 including the power supply circuit 11, the host controller 12, and the variable output power supply circuit 13. The image forming apparatus 9 can dynamically determine the power supply voltage of the device such as the short-range communication circuit 920 by the power supply voltage determination device 10, and can obtain the advantageous effects described in relation to the first embodiment.

### Second Embodiment

Next, a power supply voltage determination device according to a second embodiment will be described. The description of the same components as those of the embodiment already described will be omitted.

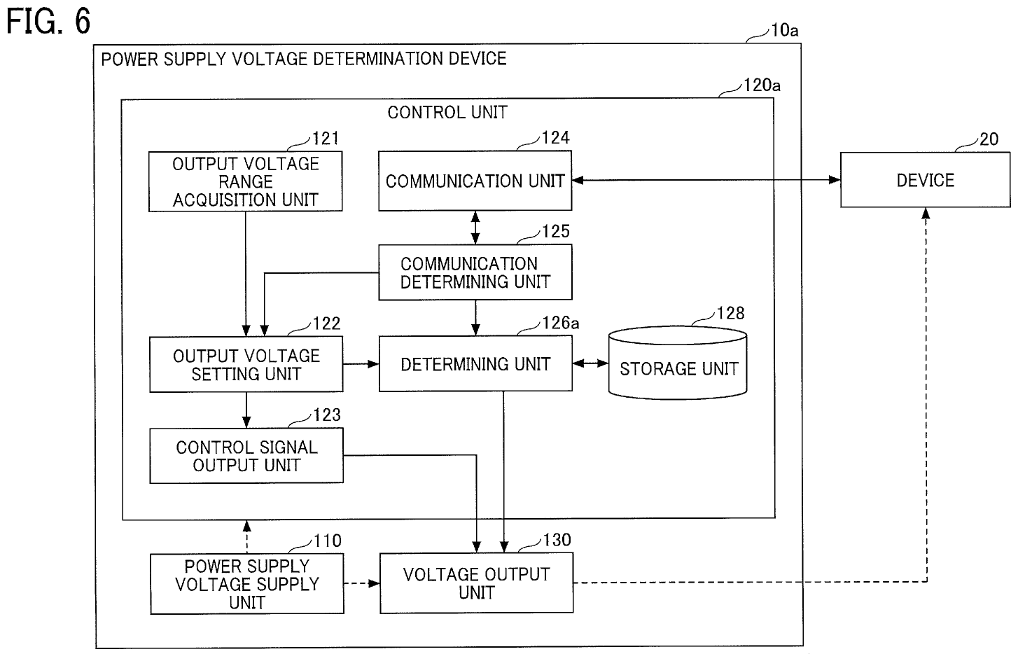

FIG. 6 is a block diagram illustrating an example of a functional configuration of the power supply voltage determination device 10a according to the present embodiment. As illustrated in FIG. 6, the power supply voltage determination device 10a has a control unit 120a. The control unit 120a also includes a determining unit 126a and a storage unit 128. With an input of a communication enabled signal from a communication determining unit 125, the determining unit 126a determines the value of the power supply voltage based on the value of the output voltage output from an output voltage setting unit 122. More specifically, the determining unit 126a determines the voltage value acquired by referring to the storage unit 128 as the value of the power supply voltage based on the value of the output voltage input from the output voltage setting unit 122.

The storage unit 128 is implemented by the HDD 144 or the like illustrated in FIG. 1 and stores a table indicating a relationship between the value of an output voltage in a case where communication with the device 20 has been successfully performed and the value of the power supply voltage. Such a table is created in advance so as to include the above-described margin voltage value based on data acquired through experiments and the like, and is stored in the storage unit 128.

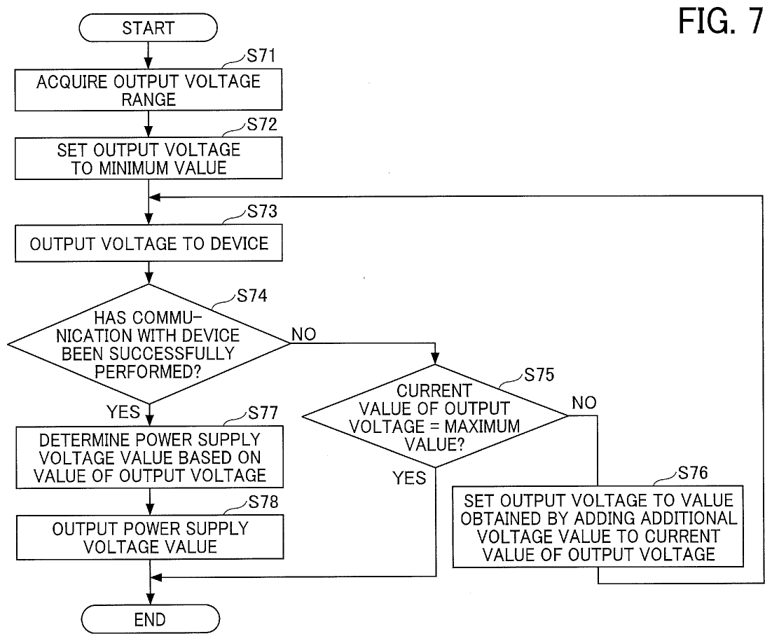

FIG. 7 is a flowchart illustrating an example of a process performed by the power supply voltage determination device 10a according to the present embodiment. The processing in steps S71 to S76 illustrated in FIG. 7 is the same as the processing in steps S41 to S46 illustrated in FIG. 4, and the processing in step S78 illustrated in FIG. 7 is the same as the processing in step S49 illustrated in FIG. 4. Thus, the overlapping description will be omitted here.

In step S77, the determining unit 126a acquires the voltage value data of the output voltage output by the output voltage setting unit 122 when the communication enabled signal is input from the communication determining unit 125, via the RAM 143 illustrated in FIG. 1. The determining unit 126a determines the voltage value acquired by referring to the storage unit 128 as the value of the power supply voltage based on the acquired voltage value data of the output voltage.

In this manner, the power supply voltage determination device 10a can determine an appropriate power supply voltage and supply the determined power supply voltage to the device 20.

As described above, in the present embodiment, the table indicating the relationship between the value of the output voltage in a case where communication with the device 20 has been successfully performed and the value of the power supply voltage is created in advance and stored in the storage unit 128. Then, the value of the power supply voltage is determined by referring to the storage unit 128 based on the output voltage when the communication between the communication unit 124 and the device 20 has been successfully performed. The appropriate power supply voltage to be supplied to the device can be dynamically determined by preliminarily determining the appropriate value of the power supply voltage including the margin voltage value with respect to the value of the output voltage in a case where communication with the device 20 has been successfully performed.

The advantageous effects other than those described above are the same as those described in relation to the first embodiment.

The embodiments of the present disclosure are not limited to the specifically disclosed above embodiments, and various modifications and changes can be made without departing from the scope of the claims.

Embodiments also include a power supply voltage determination method. For example, the power supply voltage determination method includes: a voltage output step of outputting a predetermined output voltage to a device; and a control step of controlling the voltage output step. In the control step, when the output voltage is increased, a power supply voltage to be supplied to the device is determined based on the output voltage in a case where communication with the device has been successfully performed. According to this power supply voltage determination method, the same advantageous effects as those of the power supply voltage determination device described above can be obtained.

Further, embodiments also include programs. For example, the program causes a computer to serve as a voltage output unit that outputs a predetermined output voltage to a device, and a control unit that controls the voltage output unit. According to this program under which, when increasing the output voltage, the control unit determines the output voltage to be supplied to the device based on the output voltage in a case where communication with the device has been successfully performed, the same advantageous effects as those of the power supply voltage determination device described above can be obtained.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

1. A power supply voltage determination device comprising:
a variable output power supply circuit configured to output an output voltage to a device; and
control circuitry configured to control the variable output power supply circuit,
wherein the control circuitry determines a power supply voltage to be supplied to the device, based on the output voltage in a case where communication with the device has been successfully performed during an increase of the output voltage.

2. The power supply voltage determination device according to claim 1,
wherein the control circuitry determines, as the power supply voltage, a voltage value obtained by adding a margin voltage value to a voltage value of the output voltage in the case where the communication with the device has been successfully performed.

3. The power supply voltage determination device according to claim 1, comprising a memory storing a table indicating a relationship between a voltage value of the output voltage in the case where the communication with the device has been successfully performed and a voltage value of the power supply voltage,
wherein the control circuitry determines the power supply voltage with reference to the memory based on the output voltage in the case where the communication with the device has been successfully performed.

4. The power supply voltage determination device according to claim 1,
wherein the control circuitry acquires a minimum value and a maximum value for changing the output voltage and adds an additional voltage value to the minimum value to increase the output voltage.

5. The power supply voltage determination device according to claim 1,
wherein the control circuitry determines whether the communication with the device has been successfully performed.

6. An image processing apparatus comprising the power supply voltage determination device according to claim 1.

7. A power supply voltage determination method comprising:
outputting an output voltage to a device; and
controlling the outputting of the output voltage,
wherein the controlling includes determining a power supply voltage to be supplied to the device based on the output voltage in a case where communication with the device has been successfully performed during an increase of the output voltage.

8. A non-transitory recording medium storing computer readable program code which, when executed by one or more processors, cause the processors to perform a process, the process comprising:
outputting an output voltage to a device; and
controlling the outputting of the output voltage output,
wherein the controlling includes determining a power supply voltage to be supplied to the device based on the output voltage in a case where communication with the device has been successfully performed during an increase of the output voltage.
